(19) United States
(12) Patent Application Publication
(10) Pub. No.: US 2018/0033519 A1
(43) Pub. Date: Feb. 1, 2018

(54) THERMOPLASTIC COMPOSITES AND METHODS OF MAKING FOR ELECTRICAL EQUIPMENT INSULATION AND/OR ENCAPSULATION

(71) Applicant: COOPER TECHNOLOGIES COMPANY, Houston, TX (US)

(72) Inventors: YAN SHAO, Novi, MI (US); PRASATH BALAMURUGAN GANESAN, Chidambaram (IN); CHINMAYA R. DANDEKAR, Pune (IN); JAVED ABDURRAZZAQ MAPKAR, Toledo, OH (US)

(73) Assignee: COOPER TECHNOLOGIES COMPANY, Houston, TX (US)

(21) Appl. No.: 15/665,679

(22) Filed: Aug. 1, 2017

Related U.S. Application Data
(60) Provisional application No. 62/369,277, filed on Aug. 1, 2016.

(51) Int. Cl. H01B 3/47; H01B 3/30; H01B 3/42

(52) U.S. Cl. CPC H01B 3/47; H01B 3/421; H01B 3/305

(57) ABSTRACT

The disclosed concept pertains to thermoplastic composites, e.g., nano-filler-polymer systems, for use in insulating and/or encapsulating an electrical component to provide electrical insulation, and a protective barrier from environmental conditions. The thermoplastic composites include a polymer, e.g., polymer matrix, micro-size and/or nano-size filler(s) and additive(s). The filler(s) is specifically selected with the intent of imparting improved dielectric properties to the thermoplastic composite, as compared to the polymer absent of the filler. The additive(s) impart environmental resistive properties to the thermoplastic composite.

### CROSS-REFERENCE TO RELATED APPLICATIONS

This application claims priority under 35 U.S.C. § 119(e) from U.S. provisional patent application No. 62/369,277, entitled “THERMOPLASTIC COMPOSITES AND METHODS OF MAKING FOR ELECTRICAL EQUIPMENT ENCAPSULATION”, filed on Aug. 1, 2016, the contents of which are incorporated herein by reference.

### BACKGROUND

### 1. Field

The disclosed concept pertains generally to thermoplastic composites, methods for their preparation, and uses for electrical insulation, e.g., thermoplastic encapsulation, of indoor and outdoor electrical components.

### 2. Background

It is known in the art to use thermoset materials, e.g., epoxy materials, in electrical and electronic systems as insulation material, and to protect electrical components from short circuiting, dust and moisture. These epoxy materials are employed as adhesives, sealants, coatings, impregnants, moldings and potting compounds to produce void-free insulation around the electrical components. The epoxy materials include epoxies with amine-type curing agents and epoxies coupled with anhydride curing systems. The epoxy-amine material systems are frequently employed as adhesives, sealants, impregnants and coatings and, the epoxy-anhydride material systems are primarily employed for encapsulation and potting purposes. For example, epoxy-amine materials are used in overmolding electrical components, such as, motors, generators, transformers, switchgears, reclosers, bushings and insulators.

A specific epoxy material is selected for a given application based on multiple factors, such as, desirable dielectric properties, as well as physical and mechanical strength, chemical resistance, operating temperature range and thermal cycling, dimensional stability and, resistance to shock and vibration. The desirable dielectric properties include dielectric strength, partial discharge resistance, volume resistivity, surface resistivity, dielectric constant, arc resistance and dissipation factor. These properties can be affected by temperature and, the addition of inorganic fillers, such as, silica, alumina and glass.

It is common for electrical components to be in service for long periods of time, e.g., 30 years or more. These components are located in various environments and exposed to a wide variety of environmental conditions. Often, electrical components are located outside where they are exposed to various, and sometimes harsh, weather and temperature conditions. Ambient temperatures can range from −50° C. to 65° C., and the additional heat rise from the electrical component itself can result in temperatures up to 105° C. Weather conditions can result in exposure to sunlight, rain, snow, salt, fog and the like. When located inside, e.g., in industrial environments, the electrical components can be exposed to acids, alkalis and other chemicals, as well as dust and moisture. Therefore, it is advantageous to insulate or encapsulate, e.g., cover, the electrical components with the epoxy materials as an electrical insulator, and as a protective barrier to any adverse or detrimental environmental conditions. In the absence of the protective epoxy material, the electrical components can experience degradation and, their service reliability and life may be reduced.

There are disadvantages associated with known thermoset materials, e.g., epoxy materials, and thus, there is a desire in the art to develop suitable replacement materials. For example, thermoplastic materials have been considered as a viable replacement for the traditional epoxy materials. Thermoplastic materials exhibit advantages, such as, they are recyclable and sustainable; they can be manufactured at a lower cost and faster cycle times than epoxy resins; and they are lightweight, which provides for ease of installation. However, thermoplastic materials also have disadvantages associated therewith, such as, they have high moisture absorption; they are susceptible to ultraviolet light and ozone damage; and they generally exhibit poor environmental resistance as compared to epoxy materials.

Thus, there continues to be a need in the art to develop improved thermoplastic composites, e.g., polymers, for encapsulating and insulating electrical components, wherein the composites exhibit the desirable properties of thermoplastic materials while minimizing or precluding the disadvantages that are associated with these materials. In accordance with the disclosed concept, filler(s) and additive(s) may be added to a polymer in order to improve its electrical properties and its resistivity to environmental conditions.

### SUMMARY

The aforementioned needs and others are met by embodiments of the disclosed concept, which provide thermoplastic composites for insulating and/or encapsulating electrical components, and methods for preparing the thermoplastic composites and the insulted and/or encapsulated electrical components.

In an aspect of the disclosed concept, there is provided a thermoplastic composite insulator of an electrical component that includes a polymer; micro-size and/or nano-size filler to impart to the thermoplastic composite an improved property selected from dielectric property, partial discharge resistance, tracking resistance and combinations thereof; and one or more additives to impart at least one environmental resistive property to the thermoplastic composite. The polymer can include polyamide, polyimide, polyarylamide, fluoropolymer, polyester, polyolefin, polystyrene, cyclic olefin copolymer, and blends thereof. In certain embodiments, the polymer can be selected from polyphthalamide, polybutylene terephthalate, and blends thereof. The micro-size and/or nano-size filler can be in a form selected from micro-particle, micro-tube, micro-platelet, micro-fiber, nanoparticle, nanotube, nanoplatelet, nano-fiber, and blends thereof. The micro-size and/or nano-size filler can include silicon dioxide, titanium dioxide, aluminum oxide, zinc oxide, magnesium oxide, polyhedral oligomeric silsesquioxane (POSS), calcium carbonate, clay, glass fiber, and blends thereof.

The micro-size and/or nano-size filler can be specifically selected to render to the polymer an increase in dielectric strength, partial discharge resistance, volume resistivity, surface resistivity, arc resistance, dissipation factor, and combinations thereof, as compared to the polymer absent of the filler. The micro-size and/or nano-size filler can have a dielectric strength higher than the dielectric strength of the polymer.

The micro-size and/or nano-size filler can constitute from greater than zero to about 70 weight percent based on total weight of the thermoplastic composite.

The one or more additives can be selected from anti-oxidant, UV absorber, UV stabilizer, long-term stabilizer, fire retardant, and blends thereof. The anti-oxidant can be selected from hindered phenolic antioxidant, phosphite stabilizer, and blends thereof. The ultraviolet stabilizer additive can be selected from an ultraviolet absorber, a hindered amine light stabilizer, copper complex based heat and ultraviolet stabilizer, and blends thereof. The fire retardant can be a non-halogenated material. In certain embodiments, the fire retardant can be selected from melamine phosphate, aryl phosphate, ammonium polyphosphate, metal phosphinate, e.g., aluminum phosphinate, aluminum trihydrate, magnesium hydroxide, zinc borate, and blends thereof.

Each of the one or more additives can constitute from about 0.05 to about 2.0 weight percent or greater based on total weight of the thermoplastic composite.

In certain embodiments, the electrical component is selected from the group consisting of a switchgear, recloser and insulator.

In another aspect of the disclosed concept, a thermoplastic insulated electrical component is provided, which includes an electrical component having an exterior surface, and a thermoplastic composite applied to the exterior surface to insulate the electrical component. The thermoplastic composite includes polymer, micro-size and/or nano-size filler to impart improved dielectric properties to the thermoplastic composite, and one or more additives to impart environmental resistive properties to the thermoplastic composite, as described above.

The thermoplastic composite can be in the form of an injection or compression molded part. Further, a buffer may be positioned between the exterior surface of the electrical component and the thermoplastic composite. The buffer can be air, e.g., in the form of spacing, or a polyurethane material or a combination thereof.

In still another aspect of the disclosed concept, a method of insulating an electrical component with a thermoplastic composite is provided. The method includes obtaining the electrical component having an exterior surface; combining polymer, one or more micron-size and/or nano-size filler, which is effective to impart improved dielectric properties to the thermoplastic composite and one or more additives, which is effective to impart environmental resistive properties to the thermoplastic composite, to form a blend; injection or compression molding the blend to form an injection or compression molded shell; and positioning the electrical component within the injection or compression molded shell to encapsulate the electrical component.

### BRIEF DESCRIPTION OF THE DRAWINGS

A full understanding of the disclosed concept can be gained from the following description of the preferred embodiments when read in conjunction with the accompanying drawing in which:

FIG. 1 is a schematic of the chemical structure of cyclic olefin copolymer (COC), in accordance with certain embodiments of the disclosed concept.

### DESCRIPTION OF THE PREFERRED EMBODIMENTS

The disclosed concept generally relates to thermoplastic materials, e.g., thermoplastic composites, that are suitable replacements for known thermoset materials, e.g., epoxy materials, for insulating and/or encapsulating, e.g., covering, indoor and outdoor electrical components, as an insulating material and a protective barrier from environmental conditions. The disclosed concept also includes methods for preparing the thermoplastic composites, and methods for applying these thermoplastic composites to the electrical components. As a result of modifying a polymer, e.g., polymer matrix, with filler(s) and additive(s), the thermoplastic composites exhibit improved electrical properties and environmental resistive properties. For example, the thermoplastic composites can exhibit one or more of the following improved properties: dielectric strength, dielectric constant, partial discharge resistance, ultraviolet (UV) resistance, surface tracking resistance, hydrophobicity, e.g., resistance to water absorption, resistance to thermal expansion, tensile strength, resistance to surface degradation, breakdown strength, creep/fatigue resistance, tensile strength, and manufacturing flexibility.

The thermoplastic composites include polymer, e.g., a polymer matrix, e.g., a resin, fillers and additives. The polymer is selected from a wide variety of known polymers that exhibit high dielectric and low moisture absorption properties. The fillers, e.g., micro-size and/or nano-size fillers, are selected from a wide variety of known fillers for improving electrical performance and environmental resistive properties to the thermoplastic composites, e.g., as compared to the polymer matrix. For example, improved dielectric properties may be provided by fillers, such as, but not limited to nano alumina, nano silica, nano magnesium oxide and, mixtures and combinations thereof. The additives are selected from a wide variety of known additives for improving resistivity to environmental conditions, and for providing improved strength and thermal conductivity. For example, to improve UV and ozone resistance additives, such as, but not limited to, copper complex heat and UV stabilizers (H3350) can be used. In certain embodiments, the additives provide heat stability up to about 180° C., and a high CTI value. Additives for improving strength and thermal conductivity can include, but are not limited to, glass fibers and micro alumina particles.

Thus, the filler(s) and additive(s), respectively, can modify the resulting thermoplastic composite by improving the high dielectric and low moisture absorption properties of the polymer, as well as imparting additional desirable properties to the resulting thermoplastic composite.

The thermoplastic composite of the disclosed concept is particularly applicable for insulating and/or encapsulating a wide range of electrical components, such as, but not limited to, pole units for MV vacuum circuit breakers, switchgears, vacuum reclosers, vacuum interrupters and overhead switchgears for outdoor application.

For the purposes of this disclosure, when content is indicated as being present on a “weight basis” the content is measured as the percentage of the weight of components indicated, relative to the total weight of the composite.

In accordance with the disclosed concept, a thermoplastic composite is applied to an exterior surface of an electrical component, as an insulator, as well as a protective barrier. The thermoplastic composite can provide a variety of desirable properties based on the specific fillers and additives selected in forming the thermoplastic composite. The thermoplastic composite can be applied in a wide variety of forms known in the art, such as, but not limited to, coating, adhesive, sealant, impregnant, molding, potting and encapsulation.

A thermoplastic material is generally described as a plastic material, e.g., polymer, that becomes pliable or moldable above a specific temperature (e.g., softens or fuses with heat) and, solidifies (e.g., hardens and becomes rigid) with cooling. As previously described, the thermoplastic composites of the disclosed concept include polymer, e.g., a polymer matrix. Non-limiting examples of suitable polymers include polystyrene; fluoropolymer; thermoplastic polyimide; polyamide, e.g., polyphthalamide; polyaryl amide; nylon; polyolefin, e.g., polypropylene and polytheylene; polyester, e.g., polyethylene terephthalate (PET) and polybutylene terephthalate (PBT); cyclic olefin copolymer (COC); and blends thereof. Suitable polymers for use in the disclosed concept are commercially available, such as, polyamide and polyphthalamide (PPA) resin under the trade name Nylon 612 and Nylon HTN—ZYTEL® 77G33L NC010 and HTN51G35EF (DuPont); polybutylene terephthalate resin under the trade names PBT—CRASTIN® LW9030 NC010 (DuPont), PBT—ULTRADUR® B4450GF (BASF) and PBT—CELANEX® XFR 6842 GF30(Celanese); polyimide resin under the trade names TPI EXTEM™ UH1006(SABIC), polyaryl amide resin under the trade name IXEF® 1022 PARA—50 % glass fiber-filled (Solvay) and ethylene chlorotrifluoroethylene co-polymer resin under the trade name HIFILL® ECTFE GF25 (Techmer ESF). Nylon HTN, which is commercially available from DuPont, includes 35% glass fibers and demonstrates good hydrolysis resistance, high temperature resistance, good dielectric breakdown strength and tracking resistance. ZYTEL® HTN exhibits improved resistance to cracking and chipping during handling, toughness, recyclability and economical production.

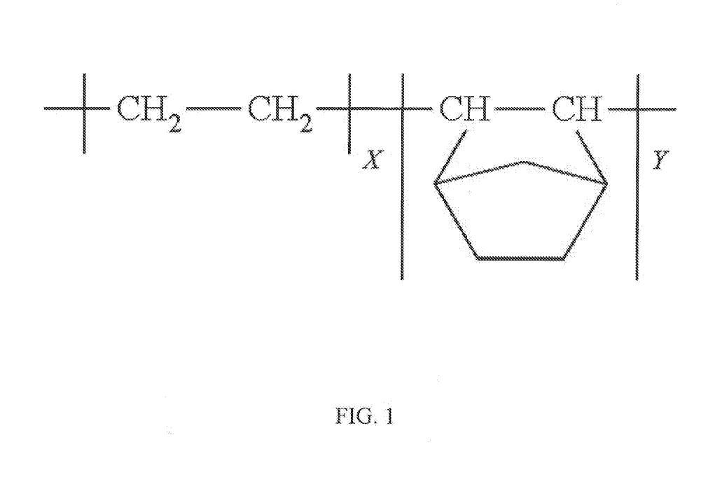

In certain embodiments, the polymer for use in the thermoplastic composites includes cyclic olefin copolymer (COC), which is a halogen-free amorphous polymer having a cyclic olefin structure. The chemical structure of COC is shown in FIG. 1. COC can be copolymerized from norbornene and ethylene using a metallocene catalyst. For example, COC can be produced by chain copolymerization of cyclic monomer, such as, 8,9,10-trinorborn-2-ene (norbornene) or 1,2,3,4,4a,5,8,8a-octahydro-1,4:5,8-dimethanonaphthalene (tetracyclododecene) with ethene. Suitable COC for use in the disclosed concept includes COC—6017 resin from Topas Advanced Polymers GmbH, which is commercially available under the trade name TOPAS®.

In certain preferred embodiments, the polymer for use in the thermoplastic composites includes polyphthalamide (PPA), also known as high-temperature nylon or nylon with higher thermal capability.

Suitable fillers for use in the disclosed concept can include a wide variety of micro-size and/or nano-size inorganic fillers, e.g., particles, tubes, platelets, fibers and blends thereof, that are known in the art. Generally, the term “nano-size” or “nanoparticle” refers to a particulate material having an average particle or grain size between 1 and 100 nanometers. Nanoparticles are distinguishable from particles having a particle size in the micron range. That is, the term “micro-size” and “microparticle” refers to particulate material having an average particle or grain size greater than about 1 μm. Nanoparticles of any size, that is, ranging from about 1 nm to less than about 100 nm can be used in the compositions of the disclosed concept.

The micro-size and/or nano-size filler can include micro-particle, micro-tube, micro-platelet, micro-fiber, nanoparticle, nanotube, nanoplatelet, nano-fiber and blends thereof, and are specifically selected and added to impart improved electrical properties to the thermoplastic composite. For example, the polymer matrix, e.g., resin, generally exhibits lower dielectric properties than the filler. One or more of the following electrical, e.g., dielectric, properties may be improved as a result of adding the filler(s) to the polymer: dielectric strength, electrical resistance, e.g., partial discharge resistance, high dielectric breakdown strength and high tracking resistance; mechanical resistance, e.g., impact, creep and thermal cycling resistance; volume resistivity; surface resistivity; arc resistance and dissipation factor.

Non-limiting examples of suitable fillers, e.g., micro-size and/or nano-size, include metal oxide, metal silicate, metal titanate, silica and blends thereof. In certain embodiments, the micro-size and/or nano-size fillers are selected from alumina, silica, silicon dioxide (SiO₂), titanium dioxide (TiO₂), aluminum dioxide (Al₂O₃), zinc oxide (ZnO), magnesium oxide (MgO), POSS, calcium carbonate (CaCO₃), clay, glass fibers, other inorganic materials, and blends thereof. These fillers may be employed to improve dielectric properties of the thermoplastic composite. In certain embodiments, the thermoplastic composites of the disclosed concept can include up to about 70 % by weight of filler(s) and/or additive(s).

Fillers, such as, glass fibers, may be used to improve mechanical properties of the thermoplastic composite; and fillers, such as, micro alumina and micro magnesia, may be used to improve thermal properties of the thermoplastic composite. For the fillers, one or more of the filler type, size and content may be specified and for the fibers, one or more of the fiber content, aspect ratio and orientation may be specified. In certain embodiments, a first filler having low dielectric strength and high dielectric constant, e.g., ceramic material, can be combined with a second material having high dielectric strength and low dielectric constant, to produce a thermoplastic composite having high dielectric strength and high dielectric constant.

The thermoplastic composites include one or more additives that are effective to impart other properties thereto, such as, but not limited to, environmental resistance, e.g., improved or low moisture absorbance and, improved or high UV, ozone and oxidation resistance, in particular, for outdoor applications. In certain embodiments, anti-oxidants, UV absorbers, UV stabilizers, long-term stabilizers, fire retardants, and blends thereof can be included in the thermoplastic composite to improve oxidation, UV absorbance, UV instability, long-term instability and flammability, respectively. Non-limiting examples of suitable anti-oxidants include hindered phenolic antioxidants, e.g., BRUGGOLEN® H3350/H3351, IRGANOX® 1010, IRGANOX® 3114, CYANOX® 1790 and IRGASTAB® FS042, which are commercially available, and phosphite stabilizers, e.g., IRGAFOS® 168, DOVER® S-9228, DOVERPHOS® TNPP and WESTON® 705, which are commercially available. Non-limiting examples of suitable UV absorbers include CYASORB® 531, TINUVIN® 328 and CYTEC® 1164, which are commercially available. Non-limiting examples of suitable UV stabilizers include copper complex based heat and UV stabilizers, hindered amine light stabilizers (HALS), e.g., TINUVIN® 770, TINUVIN® 123 and CYASORB® UV3529, which are commercially available. Pre-blended formulations of UV absorber and UV stabilizers are commercially available under the trade names TINUVIN® 791, CYASORB® UV3853, UVINYUL® 5050H and UV3346. Non-limiting examples of suitable fire retardants include non-halogenated fire retardants, such as, but not limited to, melamine phosphate, ammonium polyphosphate, aluminum phosphinate, aryl phosphate, zinc borate, aluminum trihydrate, magnesium hydroxide and, mixtures and combinations thereof. It is also believed that the addition of a fire retardant provides an improvement in the tracking index of the thermoplastic composite.

The number of additives selected and the amount of each additive employed can vary. For example, for outdoor electrical components, the thermoplastic composites may include additives for anti-oxidation, UV absorption and UV stabilization. The combination of UV absorber and UV stabilizer can provide for long-term stability. In certain embodiments, each of the selected additives for use in the thermoplastic composite can constitute from about 0.05 to about 2.0 weight percent or greater, based on total weight of the thermoplastic composite.

The thermoplastic composites can be prepared according to conventional methods and processes. For example, the polymer, e.g., polymer matrix, e.g., resin, micro-size and/or nano-size filler(s) and additive(s), can be combined together to form a mixture or blend. The order of combining these components is not critical. The combination of the polymer, filler(s) and additive(s) is typically conducted at room temperature and atmospheric pressure conditions.

The thermoplastic composites of the disclosed concept can be applied to the electrical component using various conventional methods and processes. Conventional epoxy insulation or encapsulation materials are formed using a casting process, which includes a time period, e.g., about 8-10 hours, for setting/curing. Whereas, in certain embodiments of the disclosed concept, the electrical component is directly insulated or encapsulated with the thermoplastic composite. For example, the polymer/filler/additive blend forms a thermoplastic composite that is applied, deposited or positioned onto the surface of the electrical component. In other embodiments, the electrical component is indirectly insulated or encapsulated with the thermoplastic composite. In these embodiments, an injection molding process or compression molding process, and associated apparatus are typically employed. The polymer/filler/additive mixture or blend is injected into a mold to form a thermoplastic composite shell. The electrical component is then positioned inside of this outer shell. Whether the electrical component is directly or indirectly encapsulated with the thermoplastic composite, there can be a buffer between the electrical component surface and the thermoplastic composite. The buffer may be in the form of an air space or a material, such as, but not limited to, a polyurethane potting material, positioned between the electrical component surface and the thermoplastic composite.

In certain other embodiments, the thermoplastic composite can be formed using an additive manufacturing process, and associated apparatus.

In yet other embodiments, the thermoplastic composite can be applied to the surface of the electrical component as a coating or film. The thermoplastic composite may be applied by employing conventional thermal deposition processes. Prior to applying the thermoplastic composite, the surface of the electrical component may be subjected to a preparation process. The preparation process can include a pre-coating or pre-treatment to the surface to facilitate or enhance applying and/or adhering of the thermoplastic composite thereto.

The thermoplastic composites formed can have a broad range of thicknesses. In certain embodiments, the thermoplastic composites are injected molded parts that have a thickness in a range of from about 4000 to about 6000 microns. In other embodiments, wherein the thermoplastic composites are a coating or film, the thickness can be from about 10 microns to about 225 microns.

The thermoplastic composites in accordance with the disclosed concept exhibit one or more of the following properties and characteristics: low density and water absorption; variable heat deflection temperature (up to 170° C.); high rigidity, strength and hardness; resistance to acids, alkalis, oxidation, ozone damage, UV and moisture absorption; excellent electrical properties, e.g., dielectric strength, partial discharge resistance, high breakdown strength, high tracking resistance; and mechanical properties, e.g., impact, creep, thermal cycling. Further, the thermoplastic composites are moldable, scalable, recyclable and economical. More particularly, the thermoplastic composites of the disclosed concept can provide the following improvements as compared to traditional epoxy materials:

i) less, e.g., about 15% reduction, carbon dioxide equivalent emissions when replacing epoxy encapsulation material with thermoplastic composite encapsulation material over a 30-year period;

ii) lighter weight, e.g., estimated 30-50% weight savings, when replacing epoxy encapsulation material with thermoplastic composite encapsulation material;

iii) faster processing; and

iv) reduced cost.

While specific embodiments of the disclosed concept have been described in detail, it will be appreciated by those skilled in the art that various modifications and alternatives to those details could be developed in light of the overall teachings of the disclosure. Accordingly, the particular arrangements disclosed are meant to be illustrative only and not limiting as to the scope of the disclosed concept which is to be given the full breadth of the claims appended and any and all equivalents thereof.

What is claimed is:

1. A thermoplastic composite insulator of an electrical component, comprising:
polymer;
micro-size and/or nano-size filler to impart to the thermoplastic composite an improved property selected from the group consisting of dielectric property, partial discharge resistance, tracking resistance and combinations thereof; and
one or more additives to impart at least one environmental resistive property to the thermoplastic composite.

2. The thermoplastic composite of claim 1, wherein the polymer is selected from the group consisting of polyamide, polyimide, fluoropolymer, polyester, polyolefin, polystyrene, cyclic olefin copolymer, and blends thereof.

3. The thermoplastic composite of claim 1, wherein the polymer is selected from the group consisting of polyphthalamine, polybutylene terephthalate, and blends thereof.

4. The thermoplastic composite of claim 1, wherein the filler is in a form selected from the group consisting of micro-particle, micro-tube, micro-platelet, micro-fiber, nanoparticle, nanotube, nanoplatelet, nano-fiber, and blends thereof.

5. The thermoplastic composite of claim 1, wherein the filler is selected from the group consisting of silicon dioxide, titanium dioxide, aluminum oxide, zinc oxide, magnesium oxide, polyhedral oligomeric silsesquioxane, calcium carbonate, clay, glass fiber, and blends thereof.

6. The thermoplastic composite of claim 1, wherein the filler constitutes from greater than zero to about 70 weight percent based on total weight of the thermoplastic composite.

7. The thermoplastic composite of claim 1, wherein the one or more additives is selected from the group consisting of anti-oxidant, ultraviolet absorber, ultraviolet stabilizer, long-term stabilizer, fire retardant, and blends thereof.

8. The thermoplastic composite of claim 7, wherein the anti-oxidant is selected from the group consisting of hindered phenolic antioxidant, phosphite stabilizer, and blends thereof; the ultraviolet stabilizer is selected from the group consisting of hindered amine light stabilizer, copper complex based heat and ultraviolet stabilizer, and blends thereof; the fire retardant is selected from the group consisting of melamine phosphate, ammonium polyphosphate, aluminum phosphinate, aluminum trihydrate, magnesium hydroxide, zinc borate and, blends thereof.

9. The thermoplastic composite of claim 7, wherein the fire retardant comprises a non-halogenated material.

10. The thermoplastic composite of claim 7, wherein each of the one or more additives constitutes from about 0.05 to about 2.0 weight percent or greater, based on total weight of the composite.

11. A thermoplastic insulated electrical component, comprising:
an electrical component having an exterior surface; and
a thermoplastic composite applied to the exterior surface of the electrical component, wherein the thermoplastic composite comprises:
polymer;
micron-size and/or nano-size filler to impart improved dielectric properties to the thermoplastic composite; and
one or more additives to impart environmental resistive properties to the thermoplastic composite.

12. The encapsulated electrical component of claim 11, wherein the thermoplastic composite is in a form of an injection or compression molded part.

13. The encapsulated electrical component of claim 11, wherein a buffer is positioned between the exterior surface of the electrical component and the thermoplastic composite.

14. The encapsulated electrical component of claim 11, wherein the buffer is selected from the group consisting of air, polyurethane material, and combinations thereof.

15. A method for insulating an electrical component with a thermoplastic composite, comprising:
obtaining the electrical component;
combining polymer, micron-sized and/or nano-sized filler, which is effective to impart improved dielectric properties to the thermoplastic composite and one or more additives, which is effective to impart environmental resistive properties to the thermoplastic composite, to form a blend;
injection or compression molding the blend to form an injection or compression molded shell, respectively; and
positioning the electrical component within the injection or compression molded shell.
